(19) United States
(12) Patent Application Publication
(10) Pub. No.: US 2018/0122582 A1
(43) Pub. Date: May 3, 2018

(54) WOUND CAPACITOR PACKAGE STRUCTURE WITHOUT NEGATIVE CONDUCTIVE FOIL AND WOUND ASSEMBLY THEREOF

(71) Applicant: APAQ TECHNOLOGY CO., LTD., MIAOLI COUNTY (TW)

(72) Inventors: MING-GOO CHIEN, TAICHUNG CITY (TW); SHIH-SHAN LIU, TAICHUNG CITY (TW); HSUAN-YI LIN, TAICHUNG CITY (TW)

(21) Appl. No.: 15/722,045

(22) Filed: Oct. 2, 2017

(30) Foreign Application Priority Data
Nov. 1, 2016 (TW) 105135324

(51) Int. Cl. H01G 9/15; H01G 9/08

(52) U.S. Cl. CPC H01G 9/151; H01G 2009/0014; H01G 9/08

(57) ABSTRACT

The present disclosure provides a wound capacitor package structure without negative conductive foil and a wound assembly thereof. The wound capacitor package structure includes a wound assembly, a package assembly, and a conductive assembly. The wound assembly includes a wound positive conductive foil and a wound separator paper mated with the wound positive conductive foil. The package assembly is used for enclosing the wound assembly. The conductive assembly includes a first conductive pin electrically contacting the wound positive conductive foil and a second conductive pin electrically contacting the wound separator paper. The wound separator paper has a plurality of conductive materials disposed therein, so that the wound separator paper with the conductive polymer materials can be used as a negative conductive paper.

### FIELD OF THE INVENTION

The present disclosure relates to a wound capacitor package structure and a wound assembly thereof, and more particularly to a wound capacitor package structure without negative conductive foil and a wound assembly thereof.

### BACKGROUND OF THE INVENTION

Various applications of capacitors include home appliances, computer motherboards and peripherals, power supplies, communication products and automobiles. The capacitors such as solid electrolytic capacitors are mainly used to provide the functions of filtering, bypassing, rectifying, coupling, blocking or transforming. Since the solid electrolytic capacitor has the advantages of small size, large electrical capacitance and good frequency characteristic, it can be used as a decoupling element in the power circuit of a central processing unit (CPU). In general, the capacitor elements are stacked together to form a stacked solid electrolytic capacitor with a high electrical capacitance. In addition, the stacked solid electrolytic capacitor of the prior art includes a plurality of capacitor elements and a lead frame. Each capacitor element includes an anode part, a cathode part, and an insulating part. The insulating part is insulated from the anode part and the cathode part. More specifically, the cathode parts of the capacitor elements are stacked on top of one another.

### SUMMARY OF THE INVENTION

One aspect of the present disclosure relates to a wound capacitor package structure without negative conductive foil and a wound assembly thereof.

One of the embodiments of the present disclosure provides a wound capacitor package structure without negative conductive foil, comprising a wound assembly, a package assembly, and a conductive assembly. The wound assembly includes a wound positive conductive foil and a wound separator paper mated with the wound positive conductive foil, and the wound separator paper has a plurality of conductive polymer materials disposed therein. The package assembly is used for enclosing the wound assembly. The conductive assembly includes a first conductive pin electrically contacting the wound positive conductive foil and a second conductive pin electrically contacting the wound separator paper. The first conductive pin has a first embedded portion enclosed by the package assembly and electrically contacting the wound positive conducive foil, and a first exposed portion connected to the first embedded portion and exposed out of the package assembly, and the second conductive pin has a second embedded portion enclosed by the package assembly and electrically contacting the wound separator paper, and a second exposed portion connected to the second embedded portion and exposed out of the package assembly.

Another one of the embodiments of the present disclosure provides a wound capacitor package structure without negative conductive foil, comprising a wound assembly, a package assembly, and a conductive assembly. The wound assembly includes a wound positive conductive foil and a wound separator paper mated with the wound positive conductive foil, and the wound separator paper has a plurality of conductive materials disposed therein. The package assembly is used for enclosing the wound assembly. The conductive assembly includes a first conductive pin electrically contacting the wound positive conductive foil and a second conductive pin electrically contacting the wound separator paper.

Yet another one of the embodiments of the present disclosure provides a wound assembly without negative conductive foil, the wound assembly electrically being mated with a conductive assembly, and the wound assembly comprising a wound positive conductive foil and a wound separator paper mated with the wound positive conductive foil. The wound separator paper has a plurality of conductive materials disposed therein. The conductive assembly includes a first conductive pin electrically contacting the wound positive conductive foil and a second conductive pin electrically contacting the wound separator paper, and the wound positive conductive foil and the wound separator paper are wound together to form the wound assembly.

Therefore, the wound separator paper with the conductive materials can be used as a negative conductive paper by matching the features of “the wound assembly including a wound positive conductive foil and a wound separator paper mated with the wound positive conductive foil” and “the wound separator paper having a plurality of conductive materials disposed therein”.

To further understand the techniques, means and effects of the present disclosure, the following detailed descriptions and appended drawings are hereby referred to, such that, and through which, the purposes, features and aspects of the present disclosure can be thoroughly and concretely appreciated. However, the appended drawings are provided solely for reference and illustration, without any intention to limit the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows a perspective schematic view of a wound assembly and a conductive assembly of a wound capacitor package structure according to the first embodiment of the present disclosure;

FIG. 2 shows a cross-sectional schematic view of a wound positive conductive foil and a wound separator paper of the wound assembly of the wound capacitor package structure according to the first embodiment of the present disclosure;

FIG. 3 shows a lateral schematic view of the wound capacitor package structure according to the first embodiment of the present disclosure;

FIG. 4 shows a cross-sectional schematic view of a wound positive conductive foil and a wound separator paper of another wound assembly of the wound capacitor package structure according to the first embodiment of the present disclosure;

FIG. 5 shows a lateral schematic view of another wound capacitor package structure according to the first embodiment of the present disclosure;

FIG. 6 shows a lateral schematic view of a wound capacitor package structure according to the second embodiment of the present disclosure;

FIG. 7 shows a partial schematic view of the wound assembly having a wound positive conductive foil and a first conductive pin mated with each other according to the third embodiment of the present disclosure;

FIG. 8 shows a partial schematic view of the wound assembly having a wound separator paper and a second conductive pin mated with each other according to the third embodiment of the present disclosure; and

FIG. 9 shows a perspective schematic view of the wound assembly and a conductive assembly of a wound capacitor package structure according to the third embodiment of the present disclosure.

### DETAILED DESCRIPTION OF THE PREFERRED EMBODIMENTS

Embodiments of a wound capacitor package structure without negative conductive foil and a wound assembly thereof according to the present disclosure are described herein. Other advantages and objectives of the present disclosure can be easily understood by one skilled in the art from the disclosure. The present disclosure can be applied in different embodiments. Various modifications and variations can be made to various details in the description for different applications without departing from the scope of the present disclosure. The drawings of the present disclosure are provided only for simple illustrations, but are not drawn to scale and do not reflect the actual relative dimensions. The following embodiments are provided to describe in detail the concept of the present disclosure, and are not intended to limit the scope thereof in any way.

### First Embodiment

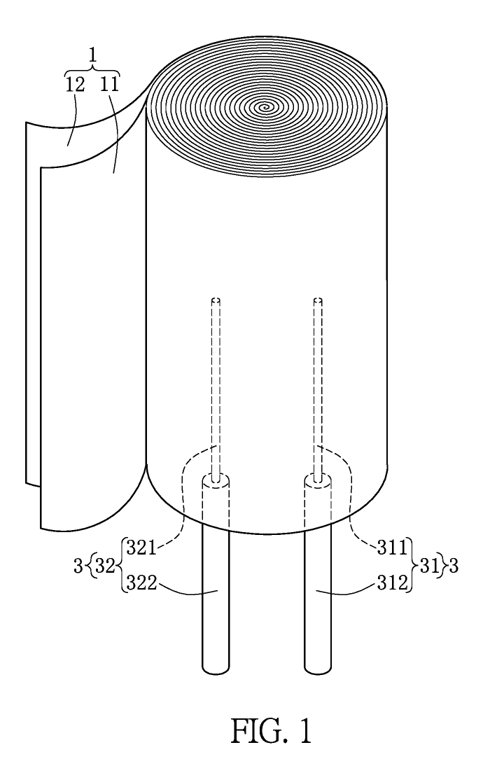

Referring to FIG. 1 to FIG. 3, the first embodiment of the present disclosure provides a wound capacitor package structure Z without negative conductive foil, including a wound assembly 1, a package assembly 2, and a conductive assembly 3.

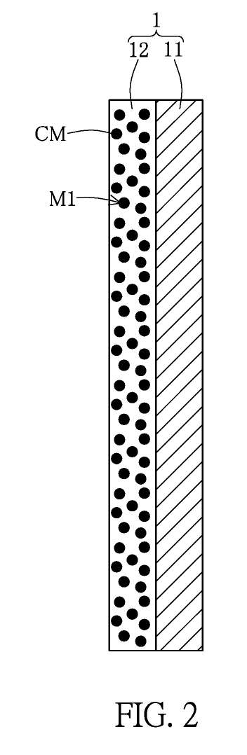

First, referring to FIG. 1 and FIG. 2, the wound assembly 1 includes a wound positive conductive foil 11 and a wound separator paper 12 mated with the wound positive conductive foil 11. That is to say, the wound positive conductive foil 11 and the wound separator paper 12 can be formed by rolling, and the wound positive conductive foil 11 and the wound separator paper 12 can be wound together to form the wound assembly 1. For example, the wound separator paper 12 has a plurality of conductive polymer materials M1 disposed therein by dipping into the conductive polymer liquid. However, it should be noted that the aforementioned description for forming the wound separator paper 12 is merely an example and is not meant to limit the scope of the present disclosure.

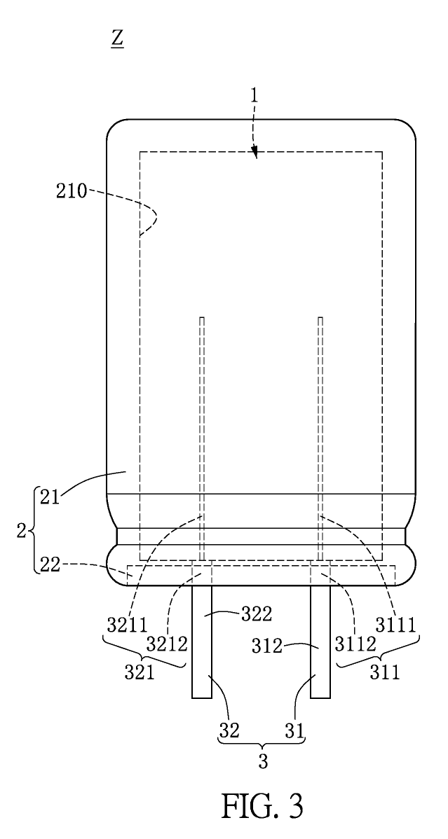

Moreover, referring to FIG. 1 and FIG. 3, the package assembly 2 is used for enclosing the wound assembly 1, so that the wound assembly 1 can be totally enclosed by the package assembly 2. For example, as shown in FIG. 3, the package assembly 2 includes a capacitor casing structure 21 (such as an aluminum casing or other metal casing) and a bottom enclosing structure 22. In addition, the capacitor casing structure 21 has a receiving space 210 for receiving the wound assembly 1, and the bottom enclosing structure 22 is disposed on a bottom side of the capacitor casing structure 21 for enclosing or closing the receiving space 210. However, it should be noted that the aforementioned description of the package assembly 2 as shown in FIG. 3 is merely an example and is not meant to limit the scope of the present disclosure. That is to say, the package assembly 2 may be an encapsulation body that can be made of any insulation material such as epoxy or silicon.

Furthermore, referring to FIG. 1 and FIG. 3, the conductive assembly 3 includes a first conductive pin 31 (such as a first conductive lead) electrically contacting the wound positive conductive foil 11 and a second conductive pin 32 (such as a second conductive lead) electrically contacting the wound separator paper 12. That is to say, as shown in FIG. 1, the first embodiment of the present disclosure provides a wound assembly 1 without negative conductive foil. The wound assembly 1 is electrically mated with a conductive assembly 3, and the wound assembly 1 includes a wound positive conductive foil 11 and a wound separator paper 12. In addition, the wound positive conductive foil 11 is mated with the wound separator paper 12, and the wound separator paper 12 has a plurality of conductive materials CM disposed therein as shown in FIG. 2. Moreover, the conductive assembly 3 includes a first conductive pin 31 electrically contacting the wound positive conductive foil 11 and a second conductive pin 32 electrically contacting the wound separator paper 12, and the wound positive conductive foil 11 and the wound separator paper 12 can be wound together to form the wound assembly 1.

More particularly, referring to FIG. 1 and FIG. 3, the first conductive pin 31 has a first embedded portion 311 enclosed by the package assembly 2 and electrically contacting the wound positive conducive foil 11, and a first exposed portion 312 connected to the first embedded portion 311 and exposed out of the package assembly 2 (being exposed from the package assembly 2). In addition, the second conductive pin 32 has a second embedded portion 321 enclosed by the package assembly 2 and electrically contacting the wound separator paper 12, and a second exposed portion 322 connected to the second embedded portion 321 and exposed out of the package assembly 2 (being exposed from the package assembly 2).

More particularly, as shown in FIG. 3, the first embedded portion 311 has a first embedded section 3111 inserted into the wound assembly 1 and fixed on the wound positive conductive foil 11, and a first exposed section 3112 connected to the first embedded section 3111 and exposed out of the wound assembly 1. In addition, the second embedded portion 321 has a second embedded section 3211 inserted into the wound assembly 1 and fixed on the wound separator paper 12, and a second exposed section 3212 connected to the second embedded section 3211 and exposed out of the wound assembly 1.

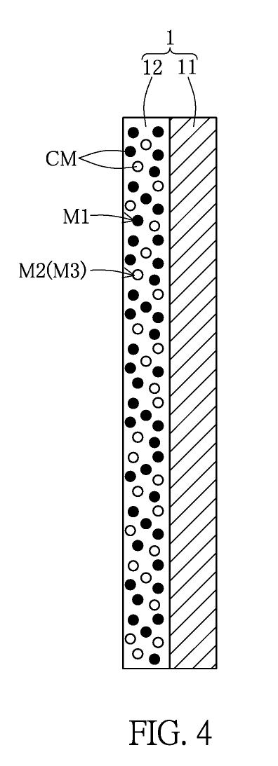

It should be noted that the wound separator paper 12 can be dipped into the conductive liquid that includes polymer and sliver (or carbon), so that the conductive polymer materials M1 and the conductive sliver materials M2 (or the conductive carbon materials M3) can be formed inside the wound separator paper 12. Therefore, the wound separator paper 12 has a plurality of conductive polymer materials M1 and a plurality of conductive sliver materials M2 (or conductive carbon materials M3) so as to decrease the dissipation factor (DF) of the wound capacitor package structure Z. That is to say, the wound separator paper 12 has a plurality of conductive polymer materials M1 as shown in FIG. 2, or the wound separator paper 12 has a plurality of conductive polymer materials M1 and a plurality of conductive sliver materials M2 (or conductive carbon materials M3) as shown in FIG. 4 according to different requirements.

For example, when the conductive polymer materials M1 are formed on the wound separator paper 12 by dipping, the wound separator paper 12 with the conductive polymer materials M1 can be used as a negative conductive paper as shown in FIG. 2. When the conductive polymer materials M1 and the conductive sliver materials M2 (or the conductive carbon materials M3) are formed on the wound separator paper 12 by dipping, not only the wound separator paper 12 with the conductive polymer materials M1 and the conductive sliver materials M2 (or the conductive carbon materials M3) can be used as a negative conductive paper as shown in FIG. 4, but also the dissipation factor of the wound capacitor package structure Z can be decreased.

However, it should be noted that the aforementioned description of the wound separator paper 12 with the conductive polymer materials M1 as shown in FIG. 2 or the wound separator paper 12 with the conductive polymer materials M1 and the conductive sliver materials M2 (or the conductive carbon materials M3) as shown in FIG. 4 (the wound separator paper 12 is used as a negative conductive paper as shown in FIG. 2 and FIG. 4) is merely an example and is not meant to limit the scope of the present disclosure. That is to say, the first embodiment of the present disclosure provides a wound capacitor package structure Z without negative conductive foil, and the wound capacitor package structure Z includes a wound assembly 1, a package assembly 2, and a conductive assembly 3. The wound assembly 1 includes a wound positive conductive foil 11 and a wound separator paper 12 mated with the wound positive conductive foil 11, and the wound separator paper 12 has a plurality of conductive materials CM disposed therein. The wound assembly 1 is enclosed by the package assembly 2. The conductive assembly 3 includes a first conductive pin 31 electrically contacting the wound positive conductive foil 11 and a second conductive pin 32 electrically contacting the wound separator paper 12.

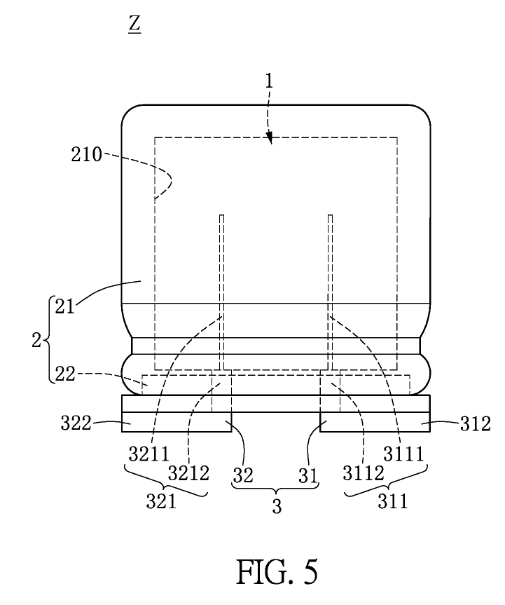

It should be noted that the wound capacitor package structure Z as shown in FIG. 3 can be replaced by the wound capacitor package structure Z as shown in FIG. 5. The difference between the wound capacitor package structure Z as shown in FIG. 3 and the wound capacitor package structure Z as shown in FIG. 5 is as follows: the first exposed portion 312 of the first conductive pin 31 and the second exposed portion 322 of the second conductive pin 32 can be bent about 90 degrees and extended toward two opposite directions as shown in FIG. 5.

More particularly, as shown in FIG. 1, the wound assembly 1 of the wound capacitor package structure Z can be formed by matching the wound positive conductive foil 11 and the wound separator paper 12 without using any negative conductive foil, so that the electric capacity (capacitance) of the wound capacitor package structure Z can be increased without changing the whole volume of the wound capacitor package structure Z, or the whole volume of the wound capacitor package structure Z can be decreased without changing the electric capacity of the wound capacitor package structure Z. In addition, the wound capacitor package structure Z can omit the negative conductive foil, so that the total electric capacity of the wound capacitor package structure Z can be defined or determined by the size and the area of the wound positive conductive foil 11.

### Second Embodiment

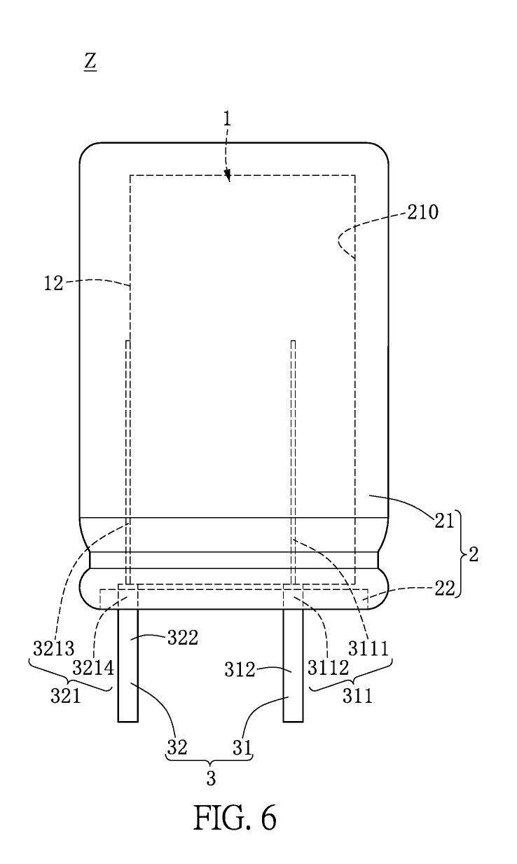

Referring to FIG. 6, the second embodiment of the present disclosure provides a wound capacitor package structure Z without negative conductive foil, including a wound assembly 1, a package assembly 2, and a conductive assembly 3. The conductive assembly 3 includes a first conductive pin 31 electrically contacting the wound positive conductive foil 11 and a second conductive pin 32 electrically contacting the wound separator paper 12. The first conductive pin 31 has a first embedded portion 311 and a first exposed portion 312, and the second conductive pin 32 has a second embedded portion 321 and a second exposed portion 322. In addition, the first embedded portion 311 has a first embedded section 3111 inserted into the wound assembly 1 and fixed on the wound positive conductive foil 11, and a first exposed section 3112 connected to the first embedded section 3111 and exposed out of the wound assembly 1.

Comparing FIG. 6 with FIG. 3, the difference between the second embodiment and the first embodiment is as follows: in the second embodiment, the second embedded portion 321 is fixed on an inner surface of a capacitor casing structure 21 and exposed out of the wound assembly 1, and the second embedded portion 321 has a contacting section 3213 separatably contacting the wound separator paper 12 and a non-contacting section 3214 connected to the contacting section 3213 and separated from the wound separator paper 12. That is to say, the second conductive pin 32 of the conductive assembly 3 can be fixed on the inner surface of the capacitor casing structure 21 in advance. When the wound assembly 1 is disposed inside the receiving space 210 of the package assembly 2, the contacting section 3213 of the second embedded portion 321 of the second conductive pin 32 can directly electrically contact the wound separator paper 12.

### Third Embodiment

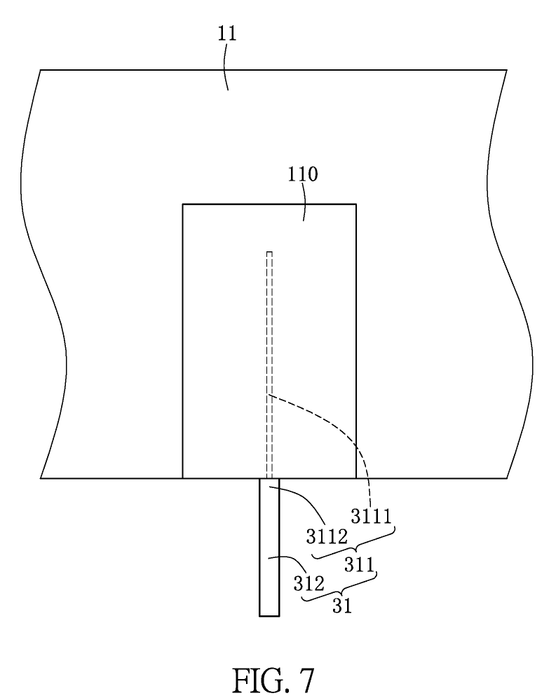

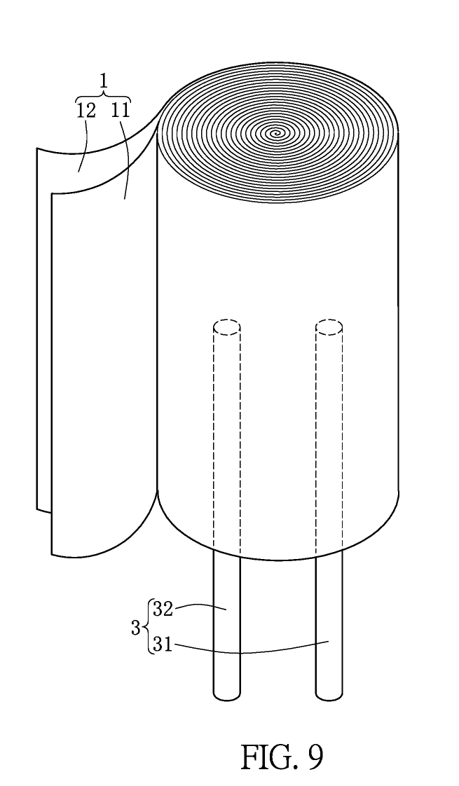

Referring to FIG. 7 to FIG. 9, the third embodiment of the present disclosure provides a wound assembly 1 without negative conductive foil. The wound assembly 1 is electrically mated with a conductive assembly 3, and the wound assembly 1 includes a wound positive conductive foil 11 and a wound separator paper 12. In addition, the conductive assembly 3 includes a first conductive pin 31 electrically contacting the wound positive conductive foil 11 and a second conductive pin 32 electrically contacting the wound separator paper 12, and the wound positive conductive foil 11 and the wound separator paper 12 can be wound together to form the wound assembly 1.

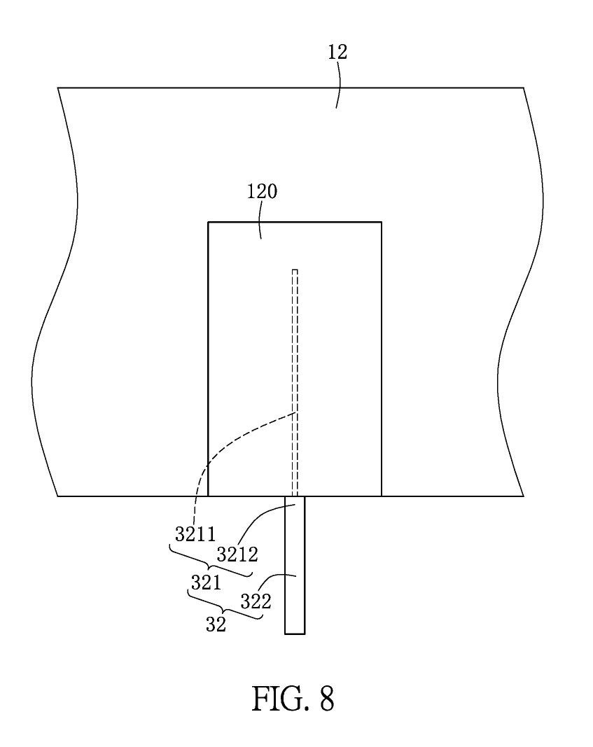

More particularly, as shown in FIG. 7, the wound positive conductive foil 11 has a first insulating covering layer 110 for covering the first embedded section 3111 of the first embedded portion 311, and the first embedded section 3111 of the first embedded portion 311 and the wound separator paper 12 are separated and insulated from each other via the first insulating covering layer 110. In addition, as shown in FIG. 8, the wound separator paper 12 has a second insulating covering layer 120 for covering the second embedded section 3211 of the second embedded portion 321, and the second embedded section 3211 of the second embedded portion 321 and the wound positive conductive foil 11 are separated and insulated from each other via the second insulating covering layer 120.

In conclusion, the wound separator paper 12 with the conductive materials CM can be used as a negative conductive paper by matching the features of “the wound assembly 1 including a wound positive conductive foil 11 and a wound separator paper 12 mated with the wound positive conductive foil 11” and “the wound separator paper 12 having a plurality of conductive materials CM disposed therein”.

It should be noted that the wound separator paper 12 can be dipped into the conductive liquid that includes polymer and sliver (or carbon), so that the conductive polymer materials M1 and the conductive sliver materials M2 (or the conductive carbon materials M3) can be formed inside the wound separator paper 12. Therefore, the wound separator paper 12 has a plurality of conductive polymer materials M1 and a plurality of conductive sliver materials M2 (or conductive carbon materials M3) so as to decrease the dissipation factor (DF) of the wound capacitor package structure Z.

More particularly, the wound assembly 1 of the wound capacitor package structure Z can be formed without the negative conductive foil, so that the electric capacity of the wound capacitor package structure Z can be increased without changing the whole volume of the wound capacitor package structure Z, or the whole volume of the wound capacitor package structure Z can be decreased without changing the electric capacity of the wound capacitor package structure Z. In addition, the wound capacitor package structure Z can omit the negative conductive foil, so that the total electric capacity of the wound capacitor package structure Z can be defined or determined by the size and the area of the wound positive conductive foil 11.

The aforementioned descriptions merely represent the preferred embodiments of the present disclosure, without any intention to limit the scope of the present disclosure which is fully described only within the following claims. Various equivalent changes, alterations or modifications based on the claims of the present disclosure are all, consequently, viewed as being embraced by the scope of the present disclosure.

What is claimed is:

1. A wound capacitor package structure without negative conductive foil, comprising:
a wound assembly including a wound positive conductive foil and a wound separator paper mated with the wound positive conductive foil, wherein the wound separator paper has a plurality of conductive polymer materials disposed therein;
a package assembly for enclosing the wound assembly; and
a conductive assembly including a first conductive pin electrically contacting the wound positive conductive foil and a second conductive pin electrically contacting the wound separator paper, wherein the first conductive pin has a first embedded portion enclosed by the package assembly and electrically contacting the wound positive conducive foil, and a first exposed portion connected to the first embedded portion and exposed out of the package assembly, and the second conductive pin has a second embedded portion enclosed by the package assembly and electrically contacting the wound separator paper, and a second exposed portion connected to the second embedded portion and exposed out of the package assembly.

2. The wound capacitor package structure of claim 1, wherein the first embedded portion has a first embedded section inserted into the wound assembly and fixed on the wound positive conductive foil, and a first exposed section connected to the first embedded section and exposed out of the wound assembly, wherein the second embedded portion has a second embedded section inserted into the wound assembly and fixed on the wound separator paper, and a second exposed section connected to the second embedded section and exposed out of the wound assembly.

3. The wound capacitor package structure of claim 2, wherein the wound positive conductive foil has a first insulating covering layer for covering the first embedded section of the first embedded portion, and the first embedded section of the first embedded portion and the wound separator paper are separated and insulated from each other via the first insulating covering layer, wherein the wound separator paper has a second insulating covering layer for covering the second embedded section of the second embedded portion, and the second embedded section of the second embedded portion and the wound positive conductive foil are separated and insulated from each other via the second insulating covering layer.

4. The wound capacitor package structure of claim 1, wherein the first embedded portion has a first embedded section inserted into the wound assembly and fixed on the wound positive conductive foil, and a first exposed section connected to the first embedded section and exposed out of the wound assembly, wherein the second embedded portion is fixed on an inner surface of a capacitor casing structure and exposed out of the wound assembly, and the second embedded portion has a contacting section separatably contacting the wound separator paper and a non-contacting section connected to the contacting section and separated from the wound separator paper.

5. The wound capacitor package structure of claim 1, wherein the package assembly includes a capacitor casing structure and a bottom enclosing structure, the capacitor casing structure has a receiving space for receiving the wound assembly, and the bottom enclosing structure is disposed on a bottom side of the capacitor casing structure for closing the receiving space, wherein the wound separator paper has a plurality of conductive sliver materials or conductive carbon materials so as to decrease the dissipation factor of the wound capacitor package structure.

6. A wound capacitor package structure without negative conductive foil, comprising:
a wound assembly including a wound positive conductive foil and a wound separator paper mated with the wound positive conductive foil, wherein the wound separator paper has a plurality of conductive materials disposed therein;
a package assembly for enclosing the wound assembly; and
a conductive assembly including a first conductive pin electrically contacting the wound positive conductive foil and a second conductive pin electrically contacting the wound separator paper.

7. A wound assembly without negative conductive foil, the wound assembly electrically mated with a conductive assembly, the wound assembly comprising:
a wound positive conductive foil; and
a wound separator paper mated with the wound positive conductive foil, wherein the wound separator paper has a plurality of conductive materials disposed therein;
wherein the conductive assembly including a first conductive pin electrically contacting the wound positive conductive foil and a second conductive pin electrically contacting the wound separator paper, wherein the wound positive conductive foil and the wound separator paper are wound together to form the wound assembly.

8. The wound assembly of claim 7, wherein the first conductive pin has a first embedded portion enclosed by the package assembly and electrically contacting the wound positive conducive foil, and a first exposed portion connected to the first embedded portion and exposed out of the package assembly, and the second conductive pin has a second embedded portion enclosed by the package assembly and electrically contacting the wound separator paper, and a second exposed portion connected to the second embedded portion and exposed out of the package assembly, wherein the first embedded portion has a first embedded section inserted into the wound assembly and fixed on the wound positive conductive foil, and a first exposed section connected to the first embedded section and exposed out of the wound assembly, wherein the second embedded portion has a second embedded section inserted into the wound assembly and fixed on the wound separator paper, and a second exposed section connected to the second embedded section and exposed out of the wound assembly, wherein the wound positive conductive foil has a first insulating covering layer for covering the first embedded section of the first embedded portion, and the first embedded section of the first embedded portion and the wound separator paper are separated and insulated from each other via the first insulating covering layer, wherein the wound separator paper has a second insulating covering layer for covering the second embedded section of the second embedded portion, and the second embedded section of the second embedded portion and the wound positive conductive foil are separated and insulated from each other via the second insulating covering layer, wherein the conductive material is a conductive polymer material.

9. The wound assembly of claim 7, wherein the first conductive pin has a first embedded portion enclosed by the package assembly and electrically contacting the wound positive conducive foil, and a first exposed portion connected to the first embedded portion and exposed out of the package assembly, and the second conductive pin has a second embedded portion enclosed by the package assembly and electrically contacting the wound separator paper, and a second exposed portion connected to the second embedded portion and exposed out of the package assembly, wherein the wound positive conductive foil has a first insulating covering layer for covering the first embedded section of the first embedded portion, and the first embedded section of the first embedded portion and the wound separator paper are separated and insulated from each other via the first insulating covering layer, wherein the second embedded portion is fixed on an inner surface of a capacitor casing structure and exposed out of the wound assembly, and the second embedded portion has a contacting section separatably contacting the wound separator paper and a non-contacting section connected to the contacting section and separated from the wound separator paper, wherein the conductive material is a conductive polymer material.

10. The wound assembly of claim 7, wherein the wound separator paper has a plurality of conductive sliver materials or conductive carbon materials so as to decrease the dissipation factor of the wound capacitor package structure.
